(19) United States
(12) Patent Application Publication
(10) Pub. No.: US 2011/0229712 A1
(43) Pub. Date: Sep. 22, 2011

(54) Breathable Protecting Film

(76) Inventor: Carine Gabrielle Lefevre, Ganshoren (BE)

(21) Appl. No.: 12/989,731

(22) PCT Filed: Mar. 25, 2009
(86) PCT No.: PCT/EP2009/002182

§ 371 Date: Jun. 2, 2011

(30) Foreign Application Priority Data
May 5, 2008 (BE) BE2008/0256

(51) Int. Cl. B32B 27/18; B32B 27/30; B32B 27/40; B32B 7/12; B32B 5/16; B32B 27/08

(52) U.S. Cl. 428/324; 428/323; 428/328; 428/522; 428/423.1; 428/424.6; 428/520; 428/424.4; 428/702

(57) ABSTRACT

Breathable solar protecting film comprising a first polymeric film and a second polymeric film bond one to each other by means of a first adhesive layer. The protecting film further comprising particles allowing to reflect thermal solar radiation while allowing the visible light to pass.

The present invention relates to a breathable protecting film to be placed on transparent or substantially translucent supports, such as window structures.

By window structures, it is meant glass panels, as well as plastic panels comprising polycarbonate, polyacrylate and polymethylmethacrylate panels. Such plastic materials are strong, light, resistant, light transmitting and they can be used for window structures such as verandas, solariums, atrium windows, casements, dormer windows, domes, skylight and the like.

In construction of buildings, natural light has to be taken into account by architects, builders and owners. The fact that natural light is allowed to penetrate into buildings is an attractive building option.

Unfortunately, sunshine light causes heat and increases energy consumption and cooling costs by optional air conditioning.

Hence, rather than sacrificing natural light beauty for saving energy costs, protecting films can be applied on windows to save energy and to yield to other advantages.

More particularly, the invention relates to a breathable protecting film for a transparent support comprising:
a first breathable polymeric film having a first surface and a second surface,
a second breathable polymeric film having also a first surface and a second surface, said second surface of said first breathable polymeric film being provided to be bond to said first surface of said second film,
A first adhesive layer applied onto said first surface of said first film provided to contact said transparent support.

Such a breathable protecting film is known from WO 2005/102670.

Some drawbacks occur because some polymeric films are bond to polycarbonate, polyacrylate or polymethylmethacrylate panels. Bubbles, craters and the like can appear, thereby providing an unacceptable aesthetic appearance for the owner or for the builders. Such plastic plates such as polycarbonate or polyacrylate plates contain moisture that can create defects at the interface between the adhesive or film and the plate when moisture escapes. Defects can occur in a watertight polymeric film. This was the subject matter of the said international patent application WO 2005/102670 which described a multilayer film that is breathable and susceptible to adhere to polycarbonate and polyacrylate plates while avoiding the development of bubbles, craters or tunnelling following moisture escapement from the plastic plate.

Unfortunately, the multilayer film of WO 2005/102670 does not allow to reach acceptable durability for the owner of the building. Indeed, it has been observed that ultraviolet radiations reflected by the multilayer film are concomitantly absorbed by the second polymeric film, which was, according to WO 2005/102670, made of a stabilized clear polyvinylchloride layer. Hence, the multilayer accumulates a high heat amount that accelerates film degradation. Further, the transmitted light ratio was only 20%. The heat accumulation caused brown-black area formation in the adherent protecting film adhering to the transparent support.

It is an object of the invention to palliate at least some of these drawbacks by providing a breathable protecting film that present an increased life with respect to the breathable film according to WO 2005/102670 while allowing an increased light transmission.

Thus, the present invention relates to a breathable protecting film as defined in the claims.

To this end, the invention provides a breathable protecting film, as mentioned in the beginning, comprising particles able to reflect solar radiation having a wavelength greater than 750 nm while allowing the transmission of visible light.

By this way, the thermal radiation (IR) which presents a wavelength greater than 750 nm is reflected by the protecting film according to the invention and the degradation due to the thermal radiation is substantially reduced, due to the presence of the particles; while the visible light is allowed to be transmitted across the breathable protecting film according to the invention. In this manner, the brightness through the support upon which a protecting film according to the invention has been placed, is conserved.

Further, the protecting film according to the invention presents a conformability property that allows to place the film on curved surfaces. Indeed, generally, when durability is increased, rigidity is also increased and the protecting film can no more been stretched or becomes slightly stretchable. According to the invention, even if durability has been increased, conformability and breathable properties has been maintained.

In one embodiment, the particles are comprised within a second adhesive layer, between said first and said second polymeric film. Therefore, the manufacturing steps are greatly rendered easier because light-reflecting particles (or pigments) have not to be integrated in a polymeric film but well in an adhesive composition.

In a variant, the particles are comprised within said second polymeric film.

Therefore, both polymeric film can be co-calendered at the manufacturer of polymeric film and hence, according to the invention, it is just needed to adhesive the first adhesive layer upon the first polymeric film.

Preferably, the first polymeric film is made of polyvinylchloride.

Advantageously, the particles are chosen in the group consisting of TiO₂, Mica, ZrO₂, SnO₂, their derivates, their mixtures and are preferably made of a mixture of TiO₂, Mica, ZrO₂, and SnO₂. Those particles present the advantage that they reflect the thermal solar radiation and thus they reflect the heat while allowing the transmission of visible light and thus while allowing to obtain a ratio of transmitted light that is increased with respect to the prior art, particularly, according to the invention, the transmitted light ratio is comprised within the range from 40 to 90%, preferably within the range from 50 to 80% and more preferably of about 60%.

Further, according to the invention, the breathable property of the protecting film according to the invention is conserved in order to avoid bubble, crater and tunnel formation.

In a preferred embodiment, said particles have an average particle size comprised between 5 and 25 μm. Further, said particles are oriented in a parallel way between said first polymeric film and said second polymeric film. Those particles present a light filtering property depending on the wavelength.

In a particular embodiment, said first breathable polymeric film comprises UV stabilizer in an amount ranging from 0.5 to 5 wt % (weight percent) with respect to the polymer weight. In a variant, said first breathable polymeric film comprises amine groups, more particularly hindered amine light stabilizers (HALS) in a ratio ranging from 0.05 to 0.5 wt % with respect to the polymer weight. Advantageously, an exemplary first polymeric film comprises about 0.1 wt % HALS and about 1 wt % UV absorbers.

In this manner, the polymeric film of polyvinylchloride easily resist to environmental conditions to which it is submitted. Indeed, such a film should be able to be subjected to high temperature (due to solar radiation that pass through the second polymeric film).

In a preferred embodiment, said second polymeric film is made of polyurethane. Polyurethane present a great resistance to heat with respect to a polyvinylchloride. However, such a polyurethane layer would have been detrimental to the breathable property of the set formed by the protecting film according to the invention. However, it has been proved, surprisingly, that the breathable property has been kept at an acceptable level and that the aesthetic aspect produced by the protecting film according to the invention was satisfying.

Therefore, thanks to the presence of a more resistant polyurethane film, the film degradation due to UV, present in the film of the prior art, does no more occur according to the invention.

Advantageously, the first adhesive layer comprises an adhesive composition which is acrylic based, solvent based, clear and pressure sensitive.

In an other advantageously embodiment, said second adhesive layer (comprising optionally the particles) comprises an adhesive composition which is acrylic based, solvent based, clear and pressure sensitive.

In a preferred embodiment according to the invention, the breathable protecting film further comprises a casting sheet onto the second surface of the second polymeric film.

Other embodiments of the breathable protecting film according to the invention are mentioned in the annexed claims.

Other characteristics and advantages of the invention will appear more clearly in the light of the following description of a particular non-limiting embodiment of the invention, while referring to the figures.

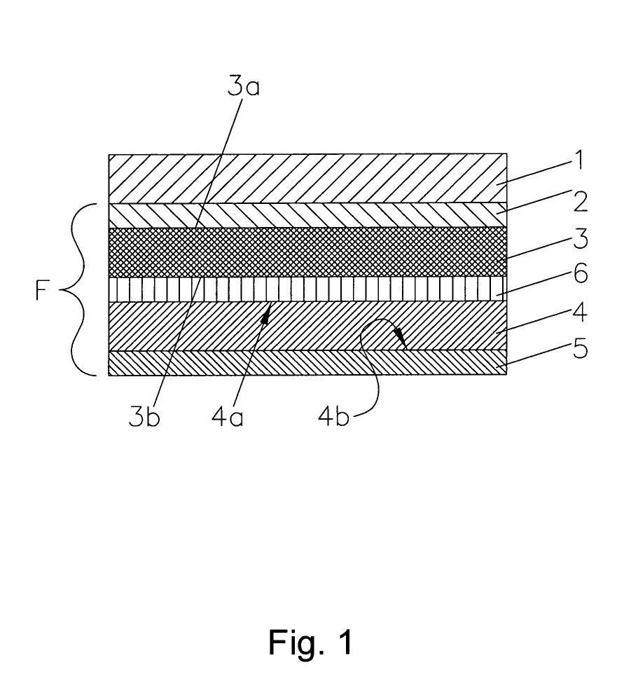

FIG. 1 is a transversal section of the protecting film according to the invention placed on a transparent support.

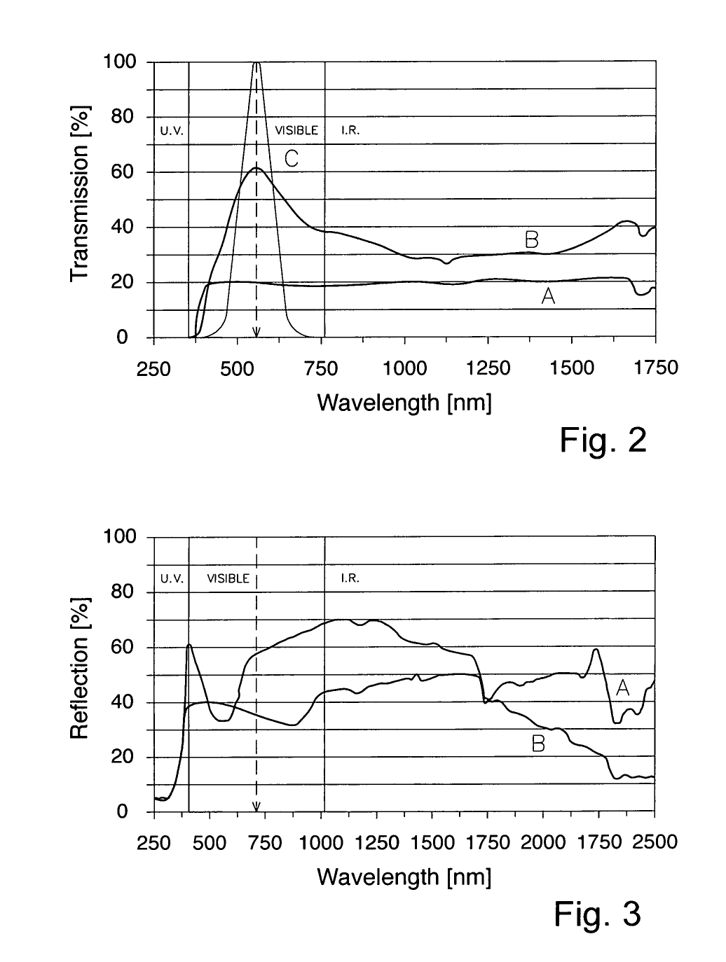

FIG. 2 is a graphic illustrating the transmission ratio of the protecting film according to the invention compared to the prior art film.

FIG. 3 is a graphic illustrating the reflection ratio of the protecting film according to the invention compared to the prior art film.

FIG. 1 illustrates a transparent support 1, coated with a protecting film F according to the invention. The protecting film F according to the invention comprises a first polymeric film made of polyvinylchloride 3 that presents a first surface 3a and a second surface 3b. This first polymeric film made of polyvinylchloride comprises UV stabilizers. This film is a breathable film that is permeable to water and allow moisture to escape from the transparent support. The protecting film further comprises a second polymeric film 4 which also presents a first surface 4a and a second surface 4b. The second film is a polyurethane film 4 with its casting sheet 5. The polyurethane (PU) film 4 increases the durability of the protecting film according to the invention and enhances the life of the covered panel in applications exposed to the environment. This transparent PU film 4 presents a thickness ranging from 30 to 60 μm and is preferably 45 μm thick. Its casting sheet presents a thickness ranging from 40 to 60 μm and is preferably 50 μm thick. The casting sheet is preferably made of polyethylene (PE). The casting sheet should be peeled off after its application upon said transparent or substantially transparent support.

The first polyvinylchloride polymeric film presents a thickness comprised in the range from 60 to 90 μm, and is preferably 75 μm.

The first polymeric layer and the second polymeric layer are contacted one to each other by an adhesive layer that contains light reflecting pigments or particles, this adhesive layer 6 is preferably translucent and weather resistant grade. By this way, the adhesive layer allows the majority of the visible light to pass. This adhesive layer 6 comprising mixed particles of TiO₂, Mica, ZrO₂, and SnO₂ present a thickness comprised in the range from 40 to 60 μm and is preferably 50 μm thick. The adhesive layer 6 is preferably an acrylic adhesive with excellent wet-out characteristics for clarity. The adhesive composition 6 is formulated to be water permeable so that moisture may escape from the transparent support 1. A preferred acrylic adhesive is a solvent-based, clear, pressure sensitive adhesive.

Further, the protecting film according to the invention also comprises a first adhesive layer 2 applied onto said first surface 3a of said first film. This adhesive layer contacts the transparent support 1 and the first polymeric film made of polyvinylchloride.

By this way, the protecting film according to the invention can adhere to plates of glass, plastic or other window structures. The transparent support can be made of polycarbonate, polyacrylate or polymethylmethacrylate (PMMA), from which moisture may escape.

The protecting film according to the invention is also suitable with glass reinforced plastic. Polymeric plates for window structures are known in the art and are typically transparent or translucent, but may require breathable films as solar control films.

The first adhesive layer 2 is preferably an acrylic adhesive composition with excellent wet-out characteristics for clarity. The first adhesive layer 2 is formulated to be water permeable so that moisture may escape from the transparent support 1. A first preferred acrylic adhesive layer according to the invention is a solvent-based, clear, pressure sensitive adhesive.

The adhesive layer 2 adheres the protecting film according to the invention to the transparent support 1. Preferably, the first adhesive layer comprises a thickness comprised in the range from 20 to 40 μm and is preferably 30 μm thick. The first adhesive layer is preferably an acrylic adhesive, as already mentioned here before, that may either permanently or temporarily adhere the protecting film to the transparent support. If the adhesive layer comprises a semi-permanent or temporary acrylic adhesive, the removal of the protecting film according to the invention is rendered easier, when such a protecting film is no more suitable.

Adhesive data for one example follows:
after 20 minutes, the release value at 180° is comprised within the range from 12 to 17 cN by 25 mm according to the FINAT n ° 1 method (FTM1);
after 24 hours, the release value at 180° is comprised within the range from 15 to 22 cN/25 mm according to the same FINAT n ° 1 method (FTM1);

The quick tack on glass is comprised within the range from 10 to 15 cN according to the FINAT n ° 9 method (FTM9) while the shear on glass (in hour, for 1 kg (25 mm×25 mm), the value was greater than 200 hours according to the FINAT n ° 8 method (FTM8).

By release value, it is meant the strength needed to peel the acrylic adhesive form the transparent support. By FINAT method, it is meant a method that defines the strength needed to split the compounds of an auto-adhesive complex according to an angle of 180° at a predetermined rate. This anti-adherence strength (delamination) is mentioned in cN by 25 mm or 50 mm width.

The protecting film according to the invention can be used on internal or external surfaces of both glass and plastic substrates.

The solar properties of the film according to the invention are described in FIG. 2 and in FIG. 3 as well as in the following table.

| | Protecting film | Protecting film |
|---|---|---|
| | not applied | applied onto a |
| | onto a transparent | transparent |
| | support | support of 4 mm |
| transmitted visible light | >50% | >40% |
| reflected visible light | <40% | <30% |
| ultraviolet black | >90% | >90% |
| Total solar energy | >50% | >40% |
| reflected | | |
| Total solar energy | <40% | <40% |
| transmitted | | |

These measurements are made with VARIAN CARY 5000 UV-VIS-NIR (UV-visible-near IR) spectrophotometer with double beam and monochromator. This spectrophotometer is equipped with an integration sphere of 150 mm of diameter (VARIAN DRA 900). This sphere gives the possibility to measure the total transmission or reflection that is diffuse and direct. The properties of light transmission has been calculated from spectral values of the transmission and of the reflection of the sample according to European norm EN 410.

The measurements have been made with an incident angle that is normal with respect to the sample. As it can be seen in FIG. 2, the protecting film according to WO 2005/102670 is represented by curve A. As it can be observed, at every wavelengths, the transmitted light ratio is nearly constant. Curve B represent the ratio of transmitted light of protecting film according to the invention. As it can be seen, the protecting film according to the invention present a maximum at the level of visible light and a minimum for wavelengths greater than 750 nm. That means that, for visible light to which human eye responds, (see curve C that represents the response of the human eye with respect to wavelength), the protecting film according to the invention allows its passing therethrough and therefore transmits the visible light, whilst the protecting film does not allow the infrared light radiations to pass therethrough, those latters generating heat.

In FIG. 3, it is the ratio of reflection that is illustrated. As it can be seen, the protecting film according to the invention presents a minimum of reflection of light in the visible portion, i.e. which does nearly not reflect visible light while the maximum of reflection is observed for wavelength greater than 750 nm. As it can be seen, the protecting film according to the invention allows to reflect heat while allowing the visible light to pass therethrough.

A release liner (not shown) is normally applied over the adhesive for easy transport. The release liner can offer stability and lay flat characteristics, and may be paper or film, in particular of polyester. When used, the release liner would be removed exposing the adhesive allowing the multilayer film to be adhered to the transparent support 1.

Although the preferred embodiments of the invention have been disclosed for illustrative purpose, those skilled in the art will appreciate that various modifications, additions or substitutions are possible, without departing from the scope and spirit of the invention as disclosed in the accompanying claims.

1. Breathable protecting film (F) for transparent or substantially translucent support (1) comprising:
a first breathable polymeric film (3) having a first surface (3a) and a second surface (3b),
a second breathable polymeric film (4) having also a first surface (4a) and a second surface (4b), said second surface (3b) of said first breathable polymeric film (3) being provided to be bond to said first surface (4a) of said second film (4),
A first adhesive layer (2) applied onto said first surface (3a) of said first film (3) provided to contact said transparent support (1),
characterized
in that said protecting film (F) comprises particles able to reflect solar radiation having a wavelength greater than 750 nm while allowing the transmission of visible light.

2. Breathable protecting film (F) according to claim 1, wherein said particles are comprised within a second adhesive layer (6), between said first (3) and said second polymeric film (4).

3. Breathable protecting film (F) according to claim 1, wherein said particles are comprised within said second polymeric film (4).

4. Breathable protecting film (F) according to anyone of the precedent claims, wherein said first breathable polymeric film (3) is made of polyvinylchloride.

5. Breathable protecting film (F) according to anyone of the precedent claims, wherein said particles are chosen in the group consisting of TiO₂, Mica, ZrO₂, SnO₂, their derivates, their mixtures and are preferably made of a mixture of TiO₂, Mica, ZrO₂, and SnO₂.

6. Breathable protecting film (F) according to anyone of the precedent claims, wherein said particles have an average particle size comprised between 5 and 25 μm.

7. Breathable protecting film (F) according to anyone of the precedent claims, wherein said particles are oriented in a parallel way between said first polymeric film (3) and said second polymeric film (4).

8. Breathable protecting film (F) according to anyone of the precedent claims, wherein said first breathable polymeric film (3) comprises UV stabilizer in an amount ranging from 0.5 to 5 wt % with respect to the polymer weight.

9. Breathable protecting film (F) according to anyone of the precedent claims, wherein said first breathable polymeric film (3) comprises amine groups, more particularly hindered amine light stabilizers (HALS) in a ratio ranging from 0.05 to 0.5 wt % with respect to the polymer weight.

10. Breathable protecting film (F) according to anyone of the precedent claims, wherein said second polymeric film (4) is made of polyurethane (4).

11. Breathable protecting film (F) according to anyone of the precedent claims, wherein said first adhesive layer comprises an adhesive composition which is acrylic based, solvent based, clear and pressure sensitive.

12. Breathable protecting film (F) according to anyone of the precedent claims, wherein said second adhesive layer comprises an adhesive composition which is acrylic based, solvent based, clear and pressure sensitive.

13. Breathable protecting film (F) according to anyone of the precedent claims, further comprising a casting sheet (5) onto the second surface (4b) of the second polymeric film (4).
